(19) United States
(12) Patent Application Publication
(10) Pub. No.: US 2022/0044506 A1
(43) Pub. Date: Feb. 10, 2022

(54) SYSTEM AND METHOD FOR ACCESSING SECURE STORAGE LOCKERS

(71) Applicant: Koloni, Inc., Des Mones, IA (US)

(72) Inventors: Brian Dewey, Mount Prospect, IL (US); Kate Lyon, Des Moines, IA (US); Kyle Sheker, Woodbury, MN (US); Bazyl Horsey, Storm Lake, IA (US); Michael Martin, Storm Lake, IA (US)

(21) Appl. No.: 17/345,394

(22) Filed: Jun. 11, 2021

Related U.S. Application Data
(60) Provisional application No. 63/063,063, filed on Aug. 7, 2020.

(51) Int. Cl. G07C 9/00; G07C 9/20

(52) U.S. Cl. CPC G07C 9/00912; G07C 2009/00769; G07C 9/215; G07C 9/00309

(57) ABSTRACT

A system comprises a locking mechanism, a mobile device, and a communication device. The communication device is configured to receive an access request from the mobile device. The communication device is further configured to, in response to receiving the access request, generate an expiring electronic key, wherein the expiring electronic key includes an expiration time. The communication device is also configured to send the expiring electronic key to the mobile device. The mobile device is configured to send the access request to the communication device and to receive the expiring electronic key from the communication device via a text message service. The mobile device is also configured to activate the expiring electronic key. The locking mechanism is configured to, in response to the mobile device activating the expiring electronic key, perform a command on the locking mechanism.

### PRIORITY CLAIM

This application claims priority to U.S. provisional patent application No. 63/063,063, filed Aug. 7, 2020, the entire contents of which are incorporated herein.

### TECHNICAL FIELD

The disclosure relates to electronic storage lockers.

### BACKGROUND

Storage lockers have an increased prevalence in today's society. With more people having more devices and valuables that they bring everywhere, activities that require more physical freedom are increasingly more difficult due to the amount of items and devices on people at any given time. Additionally, the prevalence of storage lockers are even greater due to the desire to safely, quickly, and conveniently receive food and other items delivered to an end user. Storage lockers provide a way for delivery workers to provide a quick and contactless delivery to an end user without the user needing to be present at the time of delivery while also ensuring that the delivered items do not fall into the wrong hands.

### SUMMARY

In general, the disclosure is directed to a system that includes a locking mechanism, a mobile device, and a communication device. The communication device is configured to receive an access request. The communication device is further configured to, in response to receiving the access request from the mobile device, generate an expiring electronic key. The expiring electronic key includes an expiration time. The communication device is also configured to send the expiring electronic key to the mobile device. The mobile device is configured to send the access request to the communication device and receive the expiring electronic key from the communication device via a text message service. The mobile device is also configured to activate the expiring electronic key. The locking mechanism is configured to, in response to the mobile device activating the expiring electronic key, perform a command on the locking mechanism.

In another example, the disclosure is directed to a communication device configured to receive an access request. The communication device is further configured to, in response to receiving the access request, generate an expiring electronic key, wherein the expiring electronic key includes an expiration time. The communication device is also configured to send the expiring electronic key to a mobile device via a text messaging service. The communication device is further configured to receive an activation request for the expiring electronic key and a command for a locking mechanism from the mobile device. The communication device is also configured to perform a validation process on the mobile device. The communication device is further configured to, in response to validating the mobile device, send the command to the locking mechanism.

In another example, the disclosure is directed to a method comprising receiving, by a communication device and from a mobile device, an access request. The method further includes, in response to receiving the access request, generating, by the communication device, an expiring electronic key, wherein the expiring electronic key includes an expiration time. The method also includes sending, by the communication device and via a text message service, the expiring electronic key to the mobile device. The method further includes receiving, by the mobile device, the expiring electronic key from the communication device via the text message service. The method also includes activating, by the mobile device, the expiring electronic key. The method further includes in response to activating the expiring electronic key, performing, by a locking mechanism, a command on the locking mechanism.

In another example, the disclosure is directed to a locker unit configured to perform any one or more of the techniques performed by the locker unit described above.

In another example, the disclosure is directed to a mobile device configured to perform any one or more of the techniques performed by the mobile device described above.

In another example, the disclosure is directed to a communication device configured to perform any one or more of the techniques performed by the communication device described above.

In another example, the disclosure is directed to a method comprising any of the one or more techniques performed by one or more of the locker unit, the mobile device, and the communication device described above.

In another example, the disclosure is directed to an apparatus comprising means for performing any of the one or more techniques performed by one or more of the locker unit, the mobile device, and the communication device of described above.

In another example, the disclosure is directed to a non-transitory computer-readable storage medium comprising instructions that, when executed, cause one or more processors to perform any of the one or more techniques performed by one or more of the locker unit, the mobile device, and the communication device described above.

In another example, the disclosure is directed to a device configured to perform any of the one or more techniques performed by one or more of the locker unit, the mobile device, and the communication device described above.

In another example, the disclosure is directed to any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that includes a communication device, a mobile device, and a locker unit, in accordance with one or more techniques described herein.

FIG. 2 is a block diagram illustrating a more detailed example of a communication device configured to perform the techniques described herein.

FIG. 3 is a block diagram illustrating a more detailed example of a mobile device configured to perform the techniques described herein.

FIG. 4 is a block diagram illustrating a more detailed example of a communication device configured to perform the techniques described herein.

FIG. 5 is a flow chart illustrating one or more techniques performed by the systems described herein.

### DETAILED DESCRIPTION

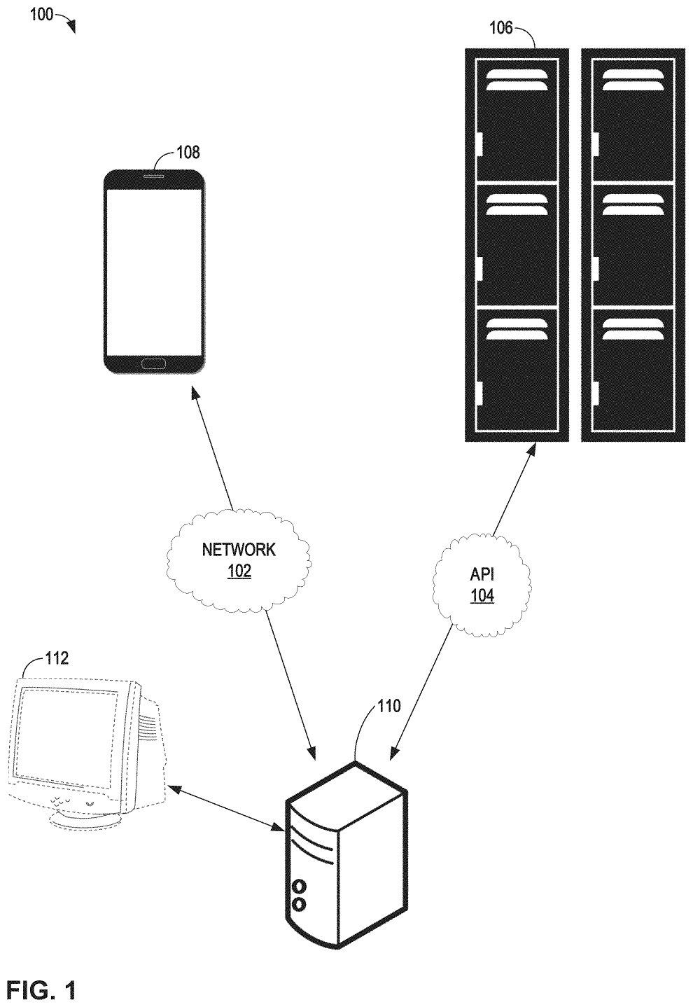

FIG. 1 is a conceptual diagram illustrating an example system 100 that includes communication device 110, mobile device 108, and locker unit 106, in accordance with one or more techniques described herein. In the example of FIG. 1, communication device 110 may be any computing device that is configured to both receive and send communications to other devices over a network while also being capable of performing internal operations to provide access control to locker unit 106 for a user of mobile device 108. For instance, communication device 110 may be any of an Internet of Things (IoT) coordination device, an applications server, a computing server, a database server, a web server, a virtual server, or another computing device configured to act as a server, such as a desktop computing device, a laptop computing device, or some other type of integrated computing device.

Mobile device 108 may be any user-operated computing device that is capable of communicating with communication device 110 over network 102 (e.g., cellular, Internet, or otherwise). In some particular instances, mobile device 108 may also be capable of utilizing global positioning system (GPS) sensors, communicating with locker unit 106 via short-wave radio communication, or outputting information for display, such as a quick response (QR) code or a barcode. For example, mobile device 108 may be a smartphone, a laptop computing device, a tablet computing device, a smartwatch device, smart headwear, or some other form of wearable or carriable computing device capable of performing the techniques described herein associated with mobile device 108.

Locking mechanism 106 may be either a standalone locking device or integrated into a locker unit, as depicted in FIG. 1. The locker unit may be any device that includes a storage compartment, with locking mechanism 106 restricting entry to the storage compartment when in a locked state and that permits entry to the storage compartment when in an unlocked state. Locking mechanism 106 has the capability to communicate with communication device 110 via application programming interface (API) 104. When integrated into a locker unit, the locker unit, in addition to or in place of locking mechanism 106, may communicate directly with communication device 110. The locker unit may act as the intermediary between locking mechanism 106 and communication device 110 in such instances. In some instances, the locker unit may include only an individual storage compartment and a single instance of locking mechanism 106, either as a standalone unit or as part of a group of units. In other instances, the locker unit itself may include a plurality of storage compartments, each with their own instance of locking mechanism 106 that are individually controllable via the techniques described herein.

In accordance with one or more techniques described herein, communication device 110 may be configured to receive an access request from mobile device 108 and for a particular locking mechanism 106, such as so that the user may access a storage compartment of a locker unit. In response to receiving the access request from mobile device 108, communication device 110 may generate an expiring electronic key that includes an expiration time. In other words, the expiring electronic key may be valid until the expiration time, which may either be a particular date and time or a relative time in relation to the time of issuance. Communication device 110 may send the expiring electronic key to mobile device 108.

In addition to sending the access request to communication device 110, mobile device 108 may also receive the expiring electronic key from communication device 110 via a text message service (e.g., a web-chat application or a simple messaging system (SMS) service). Mobile device 108 may also activate the expiring electronic key, either automatically or in response to receiving an indication of user input. Locking mechanism 106 is configured to, in response to mobile device 108 activating the expiring electronic key, perform a command (e.g., a lock command or an unlock command) on locking mechanism 106.

In a delivery situation, each time a delivery or access request goes into communication device 110 from optional communication device 112 (e.g., another communication device, similar to communication device 110, but owned and operated by a third party), communication device 110 may generate, in some instances, a random and unique string which will be appended to a base uniform resource locator (URL). In other instances, rather than a URL, communication device 110 may instead, or additionally, generate an alphanumeric code or a push notification for mobile device This webpage will then be hosted by either communication device 110 itself or another microservice that communication device 110 sends a request to while also being associated with the specific locking mechanism 106 and locker unit that was chosen for the delivery to take place at. Communication device 110 may send a text message notification to mobile device 108, which is associated with the person receiving the delivery, via an internet connection or a cellular (e.g., long-term evolution (LTE), 4G, etc.) connection so only the person receiving the delivery has access to unlock locking mechanism 106 besides the partner.

After a dedicated amount of time the webpage will ‘expire,’ meaning that if someone tries to unlock locking mechanism 106 after that selected amount of time they will be unable to do so. The reason we are doing this functionality is for security purposes. Having a unique URL that is shared between the partner and the person receiving the package is a way that only those two individuals have access to unlocking and locking the locking mechanism 106 for the time the delivery takes place. By communicating via the text messaging service, system 100 described herein does not require the use of any particular application or short-wave radio connection, although system 100 may add a verification question or a device location verification and check with the locker location or the scan of a QR code. For instance, communication device 110 could check the GPS of mobile device 108 against a known locker location for locking mechanism 106 before verifying the command. Locking mechanism 106 or the locker unit may do API calls to communication device 110 and communication device 110 may ping back to mobile device 108. Communication device 110 may also perform API communications with locking mechanism 106.

For the situation regarding the next unlock, the command may come from the same user when the functionality of locking mechanism 106 is programmed to be in its storage state. Communication device 110 will manage, in a database, who rented a locker unit that utilizes locking mechanism 106, keeping their username in the database. Since their belongings are now in the locker unit after they rented it, locking mechanism 106 will not accept any unlock or rental requests from people that are not the original renter until the original renter unlocks locking mechanism 106 again, taking their belongings out. There will also be a set time limit for the rental time to expire, by which the user will need to remove their belongings and locking mechanism 106 will be set in a state where any user can then unlock locking mechanism 106 and access the locker unit.

For API 104, as stated above with the unique URLs or other keys, the URL will be stored in the database with the other information for each locking mechanism 106. Since this will be unique, communication device 110 can query for this specific URL in the database to receive the specified locker that the user is requesting to be unlocked. After communication device 110 verifies that locker unit 106 is in an unlockable state, communication device 110 sends an unlock request either directly to locking mechanism 106 or to a second communication, such as optional communication 112, in order to actually unlock that specific locking mechanism 106. Locking mechanism 106 may be any mechanical lock connected to a microcontroller that is connected to a communication unit. The microcontroller may control locking mechanism 106 to open or close and communicate with the communication unit to communicate the status of the locking mechanism to communication device 110. Locking mechanism 106 and the locker unit may also integrate with cameras and/or sanitation devices. For instance, ultraviolet (UV) sanitation can be turned on and off between uses inside the locker unit or outside of the locker unit to disinfect between uses. Cameras could be in the locker unit to take regularly scheduled photos or to be motion activated. The locker unit could also have hot and/or cold inserts to keep contents hot or cold, e.g., keep a pizza warm until the user gets home.

The payload for unlock requests may look different based on the way locking mechanism 106 is programmed. For delivery the payload may be simple, only including the unique id that the request came from ({URL}). That is so delivery can be universal whether signed into an application or through a web browser.

For the storage functionality and rental functionality, the payload may include the username that was used when a purchased rental has been completed: {uuid, user, request: unlock}. Notice that, in this case, there may be a different way of selecting the locker uniquely. In this case, the universal unique identification number may be used since the user has specifically chosen this locker on a map or through the QR code scan. The security risks that are involved with the delivery services are minimized because, if the locker is already in use or the item is rented, communication device 110 can deny the unlock request.

Communication device 110 may manage locker states, handling requests from users that come in as well as sending unlock requests to the locking mechanism or optional communication 112. Communication device 110 may handle the whole rental process, properly updating locker unknit 106 to display its current state after each request from a user.

For an example situation, User A wants to unlock locker unit 106 to get an item inside to rent. They open an application on mobile device 108 and request an unlock. Communication device 110 receives this request {uuid, user, request: unlock} and uses the uuid field to query the database. Communication device 110 specifically will look for the locker state, if the locker state is set to ‘locked’ then it will send an unlock request to either the locking mechanism of locker unit 106 or to optional communication 112 to unlock locking mechanism 106. After optional communication 112 or locking mechanism 106 replies with a successful unlock then communication device 110 will set locking mechanism 106's state to ‘unlocked’. If locking mechanism 106 is already set to an unlocked state (or a maintenance state), then communication device 110 will respond back with an error message telling the user that locking mechanism 106 is currently unavailable for use and locking mechanism 106's status will not be updated. The same thing will happen for a lock request, the only difference being the unlocked and locked states flipped and communication device 110 sends a lock request instead of unlock.

The cellular implementation of locker deliveries may be handled by an independent micro-service in charge of primarily two actions. First, communication device 110 may allow a business to choose a phone number for the delivery to be sent to through an API POST request that includes an API key for every location so that each location is both secure and abstracted from every other location that has implemented our goods and services. Second, communication device 110 may implement a scheduling service that is initialized at the point a delivery POST is sent with a valid phone number. As such, if an organization were to implement these services into their point-of-sales (POS) system, communication device 110 would then spawn a delivery that would be authorized through the link sent via SMS or the internet with a URL encrypted link. Alternatively, communication device 110 may, in some cases, choose to authorize via a user account or pin numbers associated with a specific asset reserved for ongoing delivery. These would be attributes in a database associated with communication device 110 that can set based on customer needs for access authentication. In summary, delivery and storage systems may be an independent software interaction between a customer (business) and an end-user (business's customer), and may intersect with the services provided by communication device 110 for the purpose of storing mainline data and allow for certain operations to be administered to the delivery service through a web interface.

Communication device 110 may be, at its core, an IoT micro-controller architecture with extending capabilities for LTE cellular (CAT-1/CAT-M1) for connecting to back-ends as well as the customers. Additionally, communication device 110 also has an integrated circuit (IC) for business technology (BTE) for direct-to-consumer (D2C) communication streams. Communication device 110 has a hard-wired internal battery that can keep the battery sustained for a shorter period of time depending on use, activated IC's, and time in sleep mode (<1 week).

For use cases where the battery power needs to be extended or requires indefinite power, there are a few options. Primarily, a battery component that uses a custom I²C communication protocol to relay information related to communication device such as battery life, state warning, charging (true/false), etc. This battery does not directly funnel its current to communication device 110; instead, the battery routes energy to the internal battery when it needs to be charged. So, when the internal battery reaches a certain threshold of battery (say 20%), communication device 110 will request to be recharged by the external battery, which we will call an internal battery charging cycle. Alternative methods may include both AC current from standard outlets and solar panels that can be directed to the power intake. In the case of solar panels, it will also charge the internal battery and not communication device 110 itself, with the unique qualifications being that it will only be able to charge the battery when there is available UV to radiate the solar panel. The external battery may have a larger charge than the internal battery. For instance, the external battery may include 20,000 milliAmp hours of power, while the internal battery may only include 400 milliAmp hours of power.

The primary peripheral of communication device 110 is locking mechanism 106, such as a solenoid lock, which is electrically magnetized when receiving the request from communication device 110. Container specifications to consider is that these devices may be water-proof (in general use-cases), resistant to heat/dust/cold, and may contain a slot for an external battery pack to be removed and changed easily by an operator.

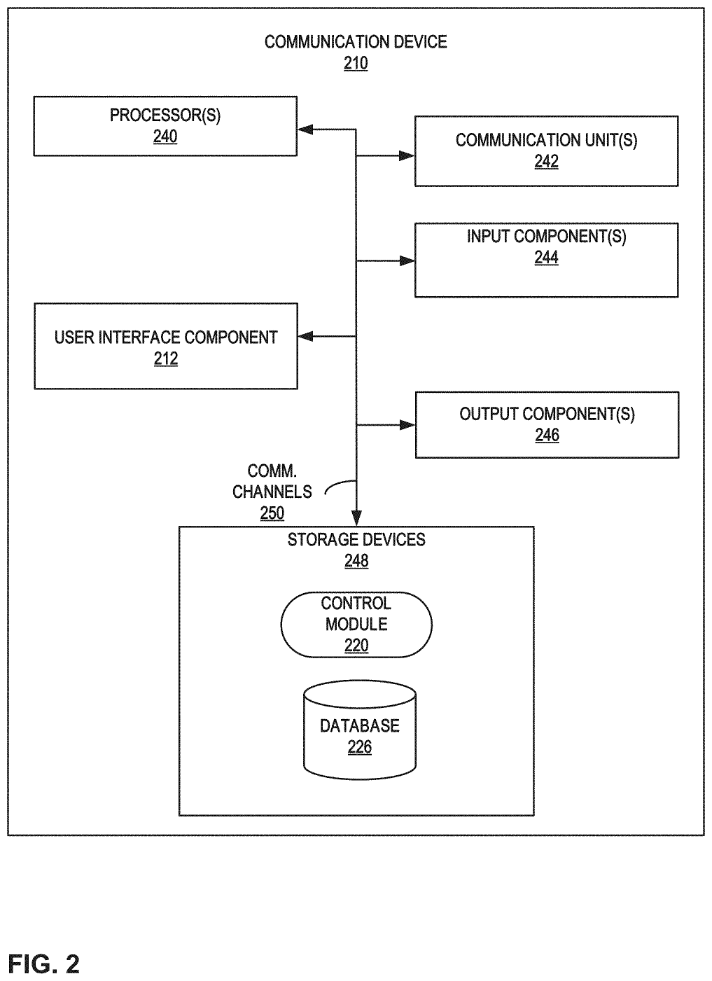

FIG. 2 is a block diagram illustrating a more detailed example of communication device 210 configured to perform the techniques described herein. Communication device 210 of FIG. 2 is described below as an example of communication device 110 of FIG. 1. FIG. 2 illustrates only one particular example of communication device 210, and many other examples of communication device 210 may be used in other instances and may include a subset of the components included in example communication device 210 or may include additional components not shown in FIG. 2.

As shown in the example of FIG. 2, communication device 210 includes user interface device (UID) 212, one or more processors 240, one or more communication units 242, one or more input components 244, one or more output components 246, and one or more storage components 248. Storage components 248 of communication device 210 include control module 220 and database 226. Communication device 210 may be, for instance, a server device, an Internet of Things (IoT) coordination device, or any other device capable of performing the various techniques described herein.

One or more processors 240 may implement functionality and/or execute instructions associated with communication device 210 to interface with a mobile device and a locker unit/locking mechanism to create a secure storage system. That is, processors 240 may implement functionality and/or execute instructions associated with communication device 210 to operate in a connected storage system that includes communication device 210, a mobile device, and a locker unit/locking mechanism.

Examples of processors 240 include application processors, display controllers, auxiliary processors, one or more sensor hubs, and any other hardware configure to function as a processor, a processing unit, or a processing device. Module 220 may be operable by processors 240 to perform various actions, operations, or functions of communication device 210. For example, processors 240 of communication device 210 may retrieve and execute instructions stored by storage components 248 that cause processors 240 to perform the operations described with respect to module 220. The instructions, when executed by processors 240, may cause communication device 210 to operate in a connected storage system that includes communication device 210, a mobile device, and a locker unit/locking mechanism.

In some examples, control module 220 may execute locally (e.g., at processors 240) to provide functions associated with displaying interface elements associated with application 218. In some examples, control module 220 may act as an interface to a remote service accessible to communication device 210.

One or more storage components 248 within communication device 210 may store information for processing during operation of communication device 210 (e.g., communication device 210 may store data accessed by module 220 during execution at communication device 210). In some examples, storage component 248 is a temporary memory, meaning that a primary purpose of storage component 248 is not long-term storage. Storage components 248 on communication device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with module 220 and database 226. Storage components 248 may include a memory configured to store data or other information associated with module 220 and database 226.

Database 226 may include objects for each locker unit/locking mechanism in the overall system. A locking mechanism may be the lock itself, while a locker unit may be an individual locker or a group of two or more lockers that each include a distinct locking mechanism. By including objects for each locker unit/locking mechanism in database 226, communication device 210 may monitor each of the locker units/locking mechanisms under its control and group this type of data together during evaluation. Each object in database 226 may include a number of data fields, some of which may include an id (e.g., auto-incrementing integer starting at 1), uuid (e.g., a unique way to identify this locker unit/locking mechanism), MAC id (e.g., id of the lock used for this locker, which may be a foreign key to another table with specific information about the lock including location, battery life, and status), partner (e.g., who owns this locker unit/locking mechanism), item (e.g., what is stored inside the locker unit/locking mechanism if the locker unit/locking mechanism is in rental mode, meaning the value may be null), state (e.g., locked, unlocked, maintenance, reserved, etc.), url (e.g., what the unique universal resource locator (URL) is if set to delivery mode, which may be null), username (e.g., some identification of who the last user was who unlocked or locked the locker, which may be null if the locker unit/locking mechanism is in delivery mode), expiration time (e.g., the time and data when the rental or delivery expires), and/or mode (e.g., delivery, rental, or storage).

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of communication device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of communication device 210 may receive input. Examples of input are tactile, audio, and video input. Input components 244 of communication device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components, such as one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of communication device 210 may generate output in a selected modality. Examples of modalities may include a tactile notification, audible notification, visual notification, machine generated voice notification, or other modalities. Output components 246 of communication device 210, in one example, includes a presence-sensitive display, sound card, video graphics adapter card, speaker, cathode ray tube (CRT) monitor, liquid crystal display (LCD), or any other type of device for generating output to a human or machine in a selected modality.

UID 212 of communication device 210 may and include a display component and a presence-sensitive input component. The display component may be a screen at which information (e.g., a visual indication) is displayed by UID 212 while the presence-sensitive input component may detect an object at and/or near the display component.

While illustrated as an internal component of communication device 210, UID 212 may also represent an external component that shares a data path with communication device 210 for transmitting and/or receiving input and output. For instance, in one example, UID 212 represents a built-in component of communication device 210 located within and physically connected to the external packaging of communication device 210 (e.g., a screen on a mobile phone). In another example, UID 212 represents an external component of communication device 210 located outside and physically separated from the packaging or housing of communication device 210 (e.g., a monitor, a projector, etc. that shares a wired and/or wireless data path with communication device 210).

UID 212 of communication device 210 may detect two-dimensional and/or three-dimensional gestures as input from a user of communication device 210. For instance, a sensor of UID 212 may detect a user's movement (e.g., moving a hand, an arm, a pen, a stylus, a tactile object, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

In accordance with the techniques described herein, control module 220 may receive an access request for altering a locking mechanism, such as if the user wishes to access a storage compartment of a locker unit. Control module 220 may receive the access request either directly from the mobile device via a network connection or from a secondary communication device.

In response to receiving the access request, control module 220 may generate an expiring electronic key. The expiring electronic key may be one or more of an expiring uniform resource locator (URL), a quick response (QR) code, a scannable barcode, or a token transmittable over short-wavelength ultra high frequency (UHF) radio waves. The expiring electronic key includes an expiration time. The expiration time may be one or more of a particular time on a particular day or a relative time in relation to a time of issuance. In response to a current time passing the expiration time, control module 220 may deactivate the expiring electronic key.

Control module 220 then sends the expiring electronic key to the mobile device. The mobile device may later activate this expiring electronic key, after which control module 220 may send a command to the locking mechanism, such as a lock command or an unlock command.

When the mobile device activates the expiring electronic key, control module 220 may receive an activation request and the command from the mobile device. Control module 220 may perform a validation process on the mobile device. Either after validating the mobile device or during the validation process (e.g., in instances when the locking mechanism performs part of the validation process), control module 220 may send the command to the locking mechanism for the locking mechanism to later perform.

In some instances, for the validation process, control module 220 may receive a location from a GPS sensor of the mobile device and compare the location to a known location of the locking mechanism. In response to determining that the mobile device is within a threshold distance of the locking mechanism (e.g., a certain number of feet, meters, or miles), control module 220 may validate the mobile device.

In other instances, for the validation process, control module 220 may generate a first QR code and end the first QR code to the mobile device. The mobile device would be configured to generate a graphical user interface that includes the first QR code and to output the graphical user interface for display on a display component of the mobile device. Control module 220 may receive, from the locking mechanism, a second QR code scanned by the locking mechanism. Control module 220 may compare the first QR code to the second QR code and, in response to the first QR code matching the second QR code, determine that the mobile device passed the validation process and send the command to the locking mechanism.

In still other instances, for the validation process, control module 220 may generate a first QR code and send the first QR code to the mobile device. The mobile device is configured to generate a graphical user interface that includes the first QR code and to output the graphical user interface for display on a display component of the mobile device. Control module 220 may also send the first QR code and the command to the locking mechanism, wherein the locking mechanism is configured to scan the first QR code output for display on the display component of the mobile device and validate the QR code.

In instances where the expiring electronic key is an expiring URL, control module 220 may store the expiring URL in database 226 such that the expiring URL is associated with the locking mechanism in database 226. Database 226 may include a plurality of fields for each object in the database, the plurality of fields including two or more of a local locker identification number, a global locker identification number, a locking mechanism identification number, a partner identification, an item description, a locking mechanism state, an expiring URL field, a current user identifier, an expiration time, and a locker mode.

When the mobile device accesses the expiring URL, control module 220 may establish a connection with the mobile device, such as a transmission control protocol (TCP) connection. Control module 220 may perform a lookup in database 226 using the expiring URL to retrieve a first object that includes the expiring URL. Control module 220 may validate one or more of the expiring URL, a username associated with the mobile device, and the global locker identification number by comparing the information in the request to the information in database 226. In response to validating the one or more of the expiring URL, a username associated with the mobile device, and the global locker identification number, control unit 220 may send the command to the locking mechanism, wherein the locking mechanism is identified in the first object.

Using database 226, control module 220 may also determine a locking mechanism state of the locking mechanism. Control module 220 may validate the command based on the locking mechanism state (e.g., that the locking mechanism is locked for an unlock command or that the locking mechanism is unlocked for a lock command). In response to validating the command, control module 220 may send the command to the locking mechanism.

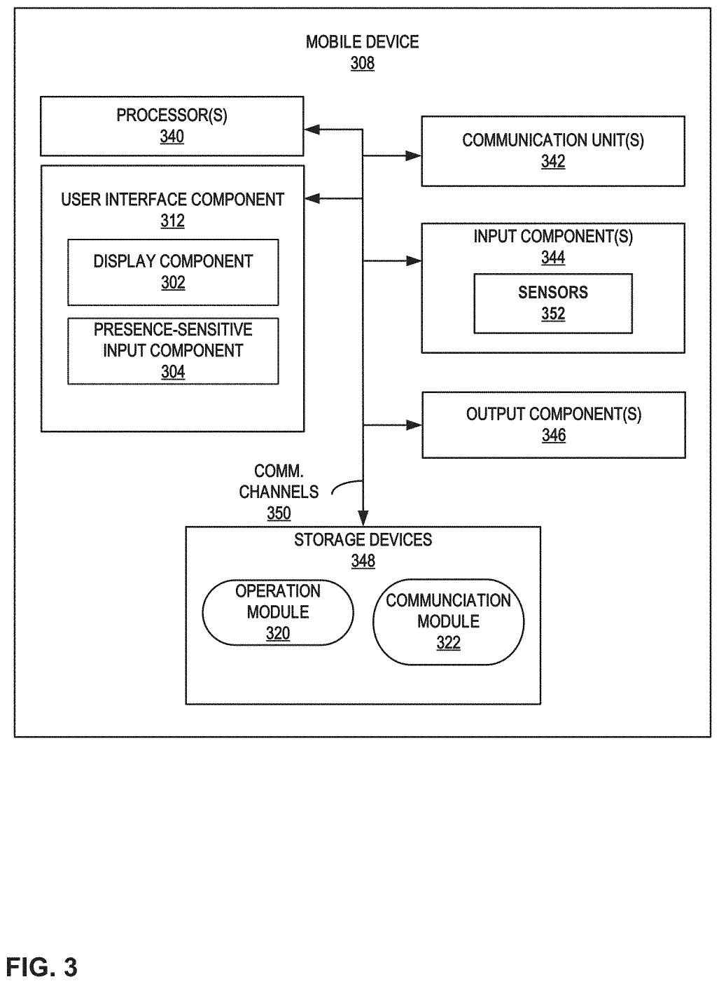

FIG. 3 is a block diagram illustrating a more detailed example of a mobile device configured to perform the techniques described herein. Mobile device 308 of FIG. 3 is described below as an example of communication device 110 of FIG. 1. FIG. 3 illustrates only one particular example of mobile device 308, and many other examples of mobile device 308 may be used in other instances and may include a subset of the components included in example mobile device 308 or may include additional components not shown in FIG. 3.

As shown in the example of FIG. 3, mobile device 308 includes user interface device (UID) 312, one or more processors 340, one or more communication units 342, one or more input components 344, one or more output components 346, and one or more storage components 348. UID 312 includes display component 302 and presence-sensitive input component 304. Storage components 348 of mobile device 308 include operation module 320 and communication module 322.

One or more processors 340 may implement functionality and/or execute instructions associated with mobile device 308 to communicate with a communication device in order to operate a locking mechanism. That is, processors 340 may implement functionality and/or execute instructions associated with mobile device 308 to operate in a connected storage system that includes mobile device 308, a communication device, and a locker unit/locking mechanism.

Examples of processors 340 include application processors, display controllers, auxiliary processors, one or more sensor hubs, and any other hardware configure to function as a processor, a processing unit, or a processing device. Modules 320 and 322 may be operable by processors 340 to perform various actions, operations, or functions of mobile device 308. For example, processors 340 of mobile device 308 may retrieve and execute instructions stored by storage components 348 that cause processors 340 to perform the operations described with respect to modules 320 and 322. The instructions, when executed by processors 340, may cause mobile device 308 to operate in a connected storage system that includes mobile device 308, a mobile device, and a locker unit/locking mechanism.

Operation module 320 may perform functionality for managing the operations of the locking mechanism and the various commands that may be given to the locking mechanism. For example, operation module 320 of mobile device 308 may execute internal operations for accessing the website and processing the expiring electronic keys received from the communication device.

Communication module 322 may perform functionality for communicating with outside devices, such as the communication device and the locking mechanism. In some examples, operation module 320 and communication module 322 may execute locally (e.g., at processors 340) to provide functions associated with displaying interface operating a locking mechanism. In some examples, operation module 320 and communication module 322 may act as an interface to a remote service accessible to mobile device 308.

One or more storage components 348 within mobile device 308 may store information for processing during operation of mobile device 308 (e.g., mobile device 308 may store data accessed by modules 320 and 322 during execution at mobile device 308). In some examples, storage component 348 is a temporary memory, meaning that a primary purpose of storage component 348 is not long-term storage. Storage components 348 on mobile device 308 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 348, in some examples, also include one or more computer-readable storage media. Storage components 348 in some examples include one or more non-transitory computer-readable storage mediums. Storage components 348 may be configured to store larger amounts of information than typically stored by volatile memory. Storage components 348 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 348 may store program instructions and/or information (e.g., data) associated with modules 320 and 322. Storage components 348 may include a memory configured to store data or other information associated with modules 320 and 322.

Communication channels 350 may interconnect each of the components 312, 340, 342, 344, 346, and 348 for inter-component communications (physically, communicatively, and/or operatively). In some examples, communication channels 350 may include a system bus, a network connection, an inter-process communication data structure, or any other method for communicating data.

One or more communication units 342 of mobile device 308 may communicate with external devices via one or more wired and/or wireless networks by transmitting and/or receiving network signals on one or more networks. Examples of communication units 342 include a network interface card (e.g. such as an Ethernet card), an optical transceiver, a radio frequency transceiver, a GPS receiver, or any other type of device that can send and/or receive information. Other examples of communication units 342 may include short wave radios, cellular data radios, wireless network radios, as well as universal serial bus (USB) controllers.

One or more input components 344 of mobile device 308 may receive input. Examples of input are tactile, audio, and video input. Input components 344 of mobile device 308, in one example, includes a presence-sensitive input device (e.g., a touch sensitive screen, a PSD), mouse, keyboard, voice responsive system, camera, microphone or any other type of device for detecting input from a human or machine. In some examples, input components 344 may include one or more sensor components, including one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 346 of mobile device 308 may generate output in a selected modality. Examples of modalities may include a tactile notification, audible notification, visual notification, machine generated voice notification, or other modalities. Output components 346 of mobile device 308, in one example, includes a presence-sensitive display, sound card, video graphics adapter card, speaker, cathode ray tube (CRT) monitor, liquid crystal display (LCD), or any other type of device for generating output to a human or machine in a selected modality.

UID 312 of mobile device 308 may include display component 302 and presence-sensitive input component 304. Display component 302 may be a screen at which information (e.g., a visual indication) is displayed by UID 312 while presence-sensitive input component 304 may detect an object at and/or near display component 302.

While illustrated as an internal component of mobile device 308, UID 312 may also represent an external component that shares a data path with mobile device 308 for transmitting and/or receiving input and output. For instance, in one example, UID 312 represents a built-in component of mobile device 308 located within and physically connected to the external packaging of mobile device 308 (e.g., a screen on a mobile phone). In another example, UID 312 represents an external component of mobile device 308 located outside and physically separated from the packaging or housing of mobile device 308 (e.g., a monitor, a projector, etc. that shares a wired and/or wireless data path with mobile device 308).

UID 312 of mobile device 308 may detect two-dimensional and/or three-dimensional gestures as input from a user of mobile device 308. For instance, a sensor of UID 312 may detect a user's movement (e.g., moving a hand, an arm, a pen, a stylus, a tactile object, etc.) within a threshold distance of the sensor of UID 312. UID 312 may determine a two or three-dimensional vector representation of the movement and correlate the vector representation to a gesture input (e.g., a hand-wave, a pinch, a clap, a pen stroke, etc.) that has multiple dimensions. In other words, UID 312 can detect a multi-dimension gesture without requiring the user to gesture at or near a screen or surface at which UID 312 outputs information for display. Instead, UID 312 can detect a multi-dimensional gesture performed at or near a sensor which may or may not be located near the screen or surface at which UID 312 outputs information for display.

In accordance with the techniques described herein, communication module 322 may be configured to receive an expiring electronic key from a communication device via a text message service. In some instances, communication module 322 may receive the expiring electronic key in response to sending an access request or in response to receiving a delivery at the locker unit for an account associated with mobile device 308. The expiring electronic key may be one or more of an expiring uniform resource locator (URL), a quick response (QR) code, a scannable barcode, or a token transmittable over short-wavelength ultra high frequency (UHF) radio waves. The expiring electronic key may include an expiration time, which may be one or more of a particular time on a particular day or a relative time in relation to a time of issuance. When a current time passes the expiration time, the communication device may deactivate the expiring electronic key.

Operation module 322 may activate the expiring electronic key, which causes the locking mechanism to perform a command on the locking mechanism. Operation module 322 may activate the expiring electronic key automatically or in response to receiving an indication of user input at input devices 344, the user input activating the expiring electronic key.

Upon activating the expiring electronic key, communication module 322 may send an activation request to a secondary communication device, where the secondary communication device sends the command to the locking mechanism. In other instances, communication module 322 may instead send the activation request and the command to the main communication device. The main communication device validates mobile device 308 and pushes the command towards the locking mechanism.

In some instances, the communication device validates the mobile device through GPS verification using sensors 352. For instance, communication module 322 may send a current location, as determined by sensors 352, to the communication device to verify that mobile device 308 is within a threshold distance of the locking mechanism.

In other instances, communication module 322 may receive a first QR code from the communication device. Operation module 322 may generate a graphical user interface that includes the first QR code and output the graphical user interface for display on display component 302. The locker unit/locking mechanism may scan the first QR code in the graphical user interface either sending the scanned code to the communication device for validation or validating the first QR code on the locker unit/locking mechanism itself.

In instances where the expiring electronic key is an expiring URL, the communication device may store the expiring URL in a database such that the expiring URL is associated with the locker unit/locking mechanism in the database. In activating the expiring URL, operation module 320 may receive an indication of user input to access the expiring URL. Operation module 320 may control a web browser to navigate to a website hosted by the communication device (or another microservice associated with the communication device) and associated with the expiring URL. The communication device may establish a connection, such as a transmission control protocol (TCP) connection, with mobile device 308. The communication device may then use a database to look up information in the database about mobile device 308 and the expiring URL to validate mobile device 308.

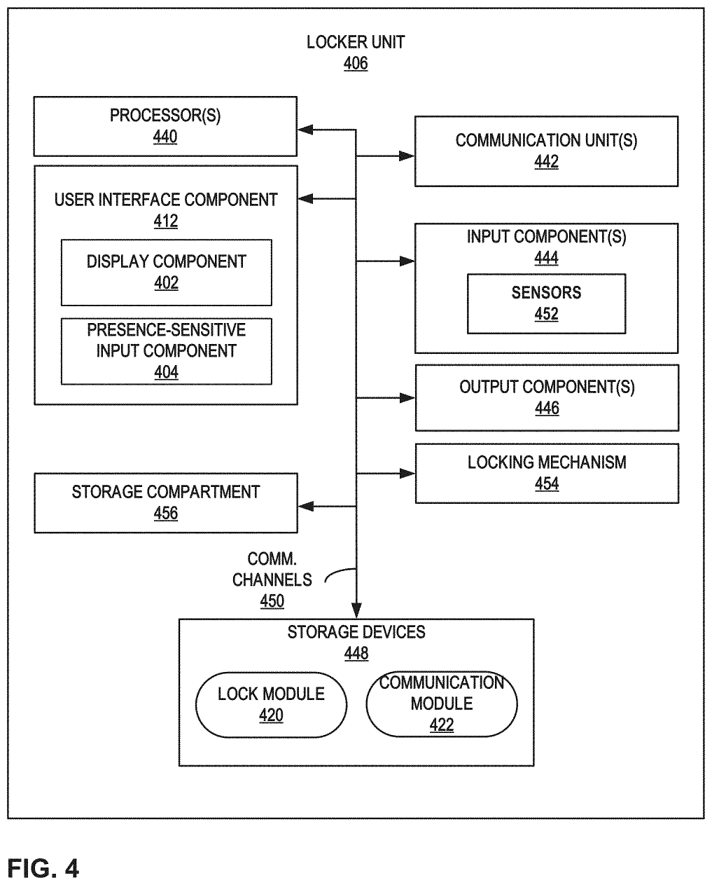

FIG. 4 is a block diagram illustrating a more detailed example of a communication device configured to perform the techniques described herein. Locker unit 406 of FIG. 4 is described below as an example of locker unit 106 of FIG. 1. FIG. 4 illustrates only one particular example of locker unit 406, and many other examples of locker unit 406 may be used in other instances and may include a subset of the components included in example locker unit 406 or may include additional components not shown in FIG. 4.

The techniques of this disclosure are described below with respect to locker unit 406, which is described as having locking mechanism 454 as an individual component of locker unit 406. It is to be understood that, rather than locker unit 406 performing the various functions, components of locker unit 406 (e.g., UIC 412, lock module 420, communication module 422, storage devices 448, input components 444, output components 446, processors 440, and communication units 442) may instead be directly implemented into locking mechanism 454. As such, locking mechanism 454 may perform the functions of locker unit 406. For any feature or function described below with respect to locker unit 406 or a component of locker unit 406, it is to be understood that these same functions could be applicable to locking mechanism 454. In other words, locking mechanism 454 may individually communicate with outside communication devices and mobile devices to lock and unlock, enabling locking mechanism 454 to be removably attached to existing/future locker structures or other containers that may include components to receive a padlock or a solenoid lock but that are not manufactured to physically incorporate such a lock. However, for simplicity, the below features are only described with respect to locker unit 406, and this description should not be understood to be limiting such that locking mechanism 454 cannot perform these functions independent of a locker unit.

As shown in the example of FIG. 4, locker unit 406 includes user interface device (UID) 412, one or more processors 440, one or more communication units 442, one or more input components 244, one or more output components 446, locking mechanism 454, storage compartment 456, and one or more storage components 448. UID 412 includes display component 402 and presence-sensitive input component 404. Storage components 448 of locker unit 406 include lock module 420 and communication module 422.

One or more processors 440 may implement functionality and/or execute instructions associated with locker unit 406 to communicate with a communication device and engage or disengage locking mechanism 454 when commands are received from a communication device and/or a mobile device. That is, processors 440 may implement functionality and/or execute instructions associated with locker unit 406 to operate in a connected storage system that includes locker unit 406, a mobile device, and a communication device.

Examples of processors 440 include application processors, display controllers, auxiliary processors, one or more sensor hubs, and any other hardware configure to function as a processor, a processing unit, or a processing device. Modules 420 and 422 may be operable by processors 440 to perform various actions, operations, or functions of locker unit 406. For example, processors 440 of locker unit 406 may retrieve and execute instructions stored by storage components 448 that cause processors 440 to perform the operations described with respect to modules 420 and 422. The instructions, when executed by processors 440, may cause locker unit 406 to operate in a connected storage system that includes locker unit 406, a mobile device, and a communication device.

Lock module 420 may perform functionalities for controlling locking mechanism 454 in response to commands received from a communication device or a mobile device. For example, lock module 420 of locker unit 406 may unlock locking mechanism 454 in response to a validated unlock command received by locker unit 406.

Communication module 422 may perform functionality for communicating with the communication device and the mobile device to receive commands. In some examples, lock module 420 and communication module 422 may execute locally (e.g., at processors 440) to provide functions associated with the connected locker system. In some examples, lock module 420 and communication module 422 may act as an interface to a remote service accessible to locker unit 406.

One or more storage components 448 within locker unit 406 may store information for processing during operation of locker unit 406 (e.g., locker unit 406 may store data accessed by modules 420 and 422 during execution at locker unit 406). In some examples, storage component 448 is a temporary memory, meaning that a primary purpose of storage component 448 is not long-term storage. Storage components 448 on locker unit 406 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 448, in some examples, also include one or more computer-readable storage media. Storage components 448 in some examples include one or more non-transitory computer-readable storage mediums. Storage components 448 may be configured to store larger amounts of information than typically stored by volatile memory. Storage components 448 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 448 may store program instructions and/or information (e.g., data) associated with modules 420 and 422. Storage components 448 may include a memory configured to store data or other information associated with modules 420 and 422.

Communication channels 450 may interconnect each of the components 412, 440, 442, 444, 446, 448, 454, and 456 for inter-component communications (physically, communicatively, and/or operatively). In some examples, communication channels 450 may include a system bus, a network connection, an inter-process communication data structure, or any other method for communicating data.

One or more communication units 442 of locker unit 406 may communicate with external devices via one or more wired and/or wireless networks by transmitting and/or receiving network signals on one or more networks. Examples of communication units 442 include a network interface card (e.g. such as an Ethernet card), an optical transceiver, a radio frequency transceiver, a GPS receiver, or any other type of device that can send and/or receive information. Other examples of communication units 442 may include short wave radios, cellular data radios, wireless network radios, as well as universal serial bus (USB) controllers.

One or more input components 444 of locker unit 406 may receive input. Examples of input are tactile, audio, and video input. Input components 444 of locker unit 406, in one example, includes a presence-sensitive input device (e.g., a touch sensitive screen, a PSD), mouse, keyboard, voice responsive system, camera, microphone or any other type of device for detecting input from a human or machine. In some examples, input components 444 may include one or more sensor components 452, including one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 446 of locker unit 406 may generate output in a selected modality. Examples of modalities may include a tactile notification, audible notification, visual notification, machine generated voice notification, or other modalities. Output components 446 of locker unit 406, in one example, includes a presence-sensitive display, sound card, video graphics adapter card, speaker, cathode ray tube (CRT) monitor, liquid crystal display (LCD), or any other type of device for generating output to a human or machine in a selected modality.

UID 412 of locker unit 406 may include display component 402 and presence-sensitive input component 404. Display component 402 may be a screen at which information (e.g., a visual indication) is displayed by UID 412 while presence-sensitive input component 404 may detect an object at and/or near display component 402.

While illustrated as an internal component of locker unit 406, UID 412 may also represent an external component that shares a data path with locker unit 406 for transmitting and/or receiving input and output. For instance, in one example, UID 412 represents a built-in component of locker unit 406 located within and physically connected to the external packaging of locker unit 406 (e.g., a screen on a mobile phone). In another example, UID 412 represents an external component of locker unit 406 located outside and physically separated from the packaging or housing of locker unit 406 (e.g., a monitor, a projector, etc. that shares a wired and/or wireless data path with locker unit 406).

UID 412 of locker unit 406 may detect two-dimensional and/or three-dimensional gestures as input from a user of locker unit 406. For instance, a sensor of UID 412 may detect a user's movement (e.g., moving a hand, an arm, a pen, a stylus, a tactile object, etc.) within a threshold distance of the sensor of UID 412. UID 412 may determine a two or three-dimensional vector representation of the movement and correlate the vector representation to a gesture input (e.g., a hand-wave, a pinch, a clap, a pen stroke, etc.) that has multiple dimensions. In other words, UID 412 can detect a multi-dimension gesture without requiring the user to gesture at or near a screen or surface at which UID 412 outputs information for display. Instead, UID 412 can detect a multi-dimensional gesture performed at or near a sensor which may or may not be located near the screen or surface at which UID 412 outputs information for display.

In accordance with the techniques described herein, locker unit 406 includes locking mechanism 454 and storage compartment 456. Storage compartment 456 may be completely enclosed with a single door, completely enclosed with doors on opposite sides such that delivery personnel can also access the interior of storage compartment 456, or may have a single door with one wall of the storage compartment missing such that delivery personnel can also access the interior of storage compartment 456. After a delivery service places an item for delivery into storage compartment 456, or when a user rents locker unit 406, after a mobile device activates an expiring electronic key, lock module 420 may perform a command (e.g., a lock command or an unlock command) on locking mechanism 454.

Communication module 422 may receive the command that lock module 420 is to perform on locking mechanism 454. Communication module 422 may receive the command either from a secondary communication device or the communication device.

Prior to lock module 420 performing the command on locking mechanism 454, the communication device and locker unit 406 may validate the mobile device. In some instances, the communication device may compare a location of the mobile device to a known location of locker unit 406 to validate that the mobile device is nearby locker unit 406. In other instances, the communication device may generate a first QR code and send the first QR code to the mobile device. The mobile device may be configured to generate a graphical user interface that includes the first QR code and to output the graphical user interface for display on a display component of the mobile device. Lock module 420 may leverage sensors 452 to scan the QR code output for display on the display component of the mobile device. In some instances, lock module 420 may compare the scanned QR code to a valid QR code received from the communication device and validate the mobile device locally if the scanned QR code matches the valid QR code. In other instances, communication module 422 may send the scanned QR code to the communication device for validation. In response to either lock module 420 or the communication device validating the mobile device, lock module 420 may perform the command on the locking mechanism.

Locker unit 406 and communication unit 442 may be configured to communicate with the communication device. For instance, locker unit 406 and communication unit 442 may communicate with the communication device via an application programming interface.

In some instances, the expiring electronic key received by the mobile device is an expiring URL, wherein the communication device is configured to store the expiring URL in a database such that the expiring URL is associated with locker unit 406 in the database. The database may include a plurality of fields for each object in the database, the plurality of fields including two or more of a local locker identification number, a global locker identification number, a locking mechanism identification number, a partner identification, an item description, a locking mechanism state, an expiring URL field, a current user identifier, an expiration time, and a locker mode.

The database may store a locking mechanism state for locking mechanism 454. The locking mechanism state may be one or more of locked, unlocked, maintenance, rented, vacant, and delivery pending. When validating the mobile device, the communication device may also verify that the command for lock module 420 to perform on locking mechanism 454 is valid based on the locking mechanism state of locking mechanism 454. Lock module 420 may only perform the command after the command has been validated.

In some instances, locker unit 406 may include additional components not pictured in FIG. 4. For instance, locker unit 406 may include an ultraviolet sanitization system, either in storage compartment 456 or on the outside of locker unit 406, which may sanitize locker unit 406 in between uses.

Locker unit 406 may also include one or more of a heating unit and a cooling unit. This would be particularly useful when locker unit 406 is configured in delivery mode, as storage compartment 456 can be configured to keep the contents of storage compartment 456 at the correct temperature.

In still other instances, locker unit 406 may include a camera as one of input components 444. The camera may be configured to capture one or more of video data and image data of at least storage compartment 456 of the locker unit. In some examples, the camera is a motion activated camera configured to begin capturing one or more of the video data and the image data upon detecting motion in or around (e.g., outside an entrance to) storage compartment 456. In other instances, the camera is configured to capture one or more of the video data and the image data at a regular interval of time (e.g., once every five minutes, once every ten minutes, once every hour, etc.).

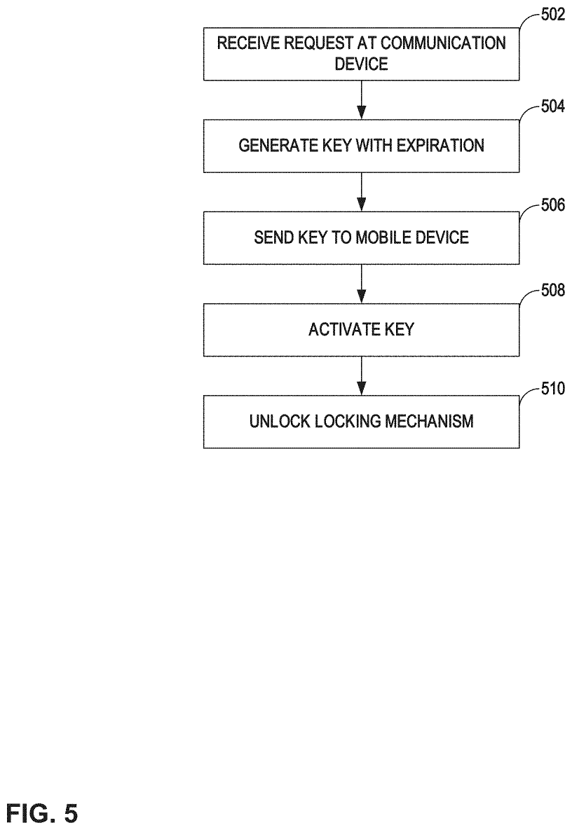

FIG. 5 is a flow chart illustrating one or more techniques performed by the systems described herein. The techniques of FIG. 5 may be performed by one or more processors of a computing device, such as system 100 of FIG. 1, communication device 210 of FIG. 2, mobile device 308 of FIG. 3, and/or locker unit 406 of FIG. 4. For purposes of illustration only, the techniques of FIG. 5 are described within the context of system 100 of FIG. 1, although systems having configurations different than that of system 100 may perform the techniques of FIG. 5.

In accordance with one or more techniques described herein, communication device 110 receives an access request, sent by mobile device 108, for a storage compartment (e.g., storage compartment 456 of FIG. 4) of locker unit 106 (502). In response to receiving the access request from the mobile device, communication device 110 generates an expiring electronic key (504). The expiring electronic key includes an expiration time. Communication device 110 then sends the expiring electronic key to mobile device 108, which receives the expiring electronic key through a text messaging service (506). Mobile device 108 activates the expiring electronic key (508). In response to mobile device 108 activating the expiring electronic key, locker unit 106 performs a command on locking mechanism 106 (e.g., locking mechanism 454 of FIG. 4), such as an unlock or a lock command (510).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A system comprising:
a locking mechanism;
a mobile device; and
a communication device configured to:
receive an access request;
in response to receiving the access request, generate an expiring electronic key, wherein the expiring electronic key includes an expiration time; and
send the expiring electronic key to the mobile device,
wherein the mobile device is configured to:
receive the expiring electronic key from the communication device via a text message service; and
activate the expiring electronic key, and
wherein the locking mechanism is configured to:
in response to the mobile device activating the expiring electronic key, perform a command on the locking mechanism.

2. The system of claim 1, wherein the mobile device being configured to activate the expiring electronic key comprises the mobile device being configured to:
receive an indication of user input activating the expiring electronic key.

3. The system of claim 2, wherein the mobile device is further configured to:
send an activation request to a secondary communication device,
wherein the locking mechanism is further configured to receive a command from the secondary communication device to unlock the locking mechanism.

4. The system of any one of claim 1, wherein the expiring electronic key comprises one or more of an expiring uniform resource locator (URL), a quick response (QR) code, a scannable barcode, or a token transmittable over short-wavelength ultra high frequency (UHF) radio waves.

5. The system of any one of claim 1, wherein the communication device being configured to receive the access request comprises the communication device being configured to receive the access request either directly from the mobile device via a network connection or from a secondary communication.

6. The system of any one of claim 1, wherein the expiration time comprises one or more of a particular time on a particular day or a relative time in relation to a time of issuance,
wherein, in response to a current time passing the expiration time, the communication device is configured to deactivate the expiring electronic key.

7. The system of claim 1, wherein the communication device comprises one or more of a server device or an Internet of Things (IoT) coordination device.

8. The system of any one of claim 1, wherein the mobile device being configured to activate the expiring electronic key comprises the mobile device being configured to send an activation request and the command to the communication device,
wherein the communication device is configured to:
perform a validation process on the mobile device; and
send the command to the locking mechanism,
wherein the locking mechanism is configured to, in response to receiving the command from the communication device, perform the command on the locking mechanism.

9. The system of claim 8, wherein the communication device being configured to perform the validation process comprises the communication device being configured to:
generate a first QR code;
send the first QR code to the mobile device, wherein the mobile device is configured to generate a graphical user interface that includes the first QR code and to output the graphical user interface for display on a display component of the mobile device;
receive, from the locking mechanism, a second QR code scanned by the locking mechanism;
compare the first QR code to the second QR code; and
in response to the first QR code matching the second QR code, determine that the mobile device passed the validation process and send the command to the locking mechanism.

10. The system of claim 8, wherein the communication device being configured to perform the validation process comprises the communication device being configured to:
generate a first QR code;
send the first QR code to the mobile device, wherein the mobile device is configured to generate a graphical user interface that includes the first QR code and to output the graphical user interface for display on a display component of the mobile device; and
send the first QR code and the command to the locker unit,
wherein the locking mechanism is configured to:
scan the first QR code output for display on the display component of the mobile device;
compare the first QR code output for display on the display component of the mobile device to the first QR code received from the communication device; and
in response to the first QR code output for display on the display component of the mobile device matching the first QR code received from the communication device, perform the command on the locking mechanism.

11. The system of claim 8, wherein the communication device being configured to perform the validation process comprises the communication device being configured to:
receive, from the mobile device, a location of the mobile device as determined by a global positioning system of the mobile device;
compare the location of the mobile device to a known location of the locking mechanism; and
in response to determining that the location of the mobile device is within a threshold distance from the known location of the locking mechanism, validate the mobile device.

12. The system of any one of claim 1, wherein the expiring electronic key comprises an expiring URL, wherein the communication device is configured to store the expiring URL in a database such that the expiring URL is associated with the locker unit in the database, wherein the database includes a plurality of fields for each object in the database, the plurality of fields including two or more of a local locker identification number, a global locker identification number, a locking mechanism identification number, a partner identification, an item description, a locking mechanism state, an expiring URL field, a current user identifier, an expiration time, and a locker mode.

13. The system of claim 12, wherein the mobile device being configured to activate the expiring electronic key comprises the mobile device being configured to:
receive an indication of user input to access the expiring URL; and
control a web browser to navigate to a website hosted by the communication device and associated with the expiring URL,
wherein the communication device is further configured to:
establish a connection with the mobile device;
perform a lookup in the database using the expiring URL to retrieve a first object that includes the expiring URL;
validate one or more of the expiring URL, a username associated with the mobile device, and the global locker identification number;
in response to validating the one or more of the expiring URL, a username associated with the mobile device, and the global locker identification number, send the command to the locking mechanism, wherein the locking mechanism is identified in the first object.

14. The system of claim 13, wherein the connection comprises a transmission control protocol (TCP) connection.

15. The system of claim 13, wherein the communication device is further configured to:
determine a locking mechanism state of the locking mechanism;
validate the command based on the locking mechanism state;
in response to validating the command, send the command to the locking mechanism.

16. The system of claim 1, wherein the locking mechanism is a standalone mechanism that comprises one or more communication units configured to receive the command from the communication device.

17. The system of claim 1, wherein the locking mechanism is physically incorporated into a locker unit comprising one or more storage compartments, wherein the locking mechanism is controlled by the locker unit to provide access to a first storage compartment of the one or more storage compartments, and wherein the locker unit further comprises the communication device.

18. The system of claim 17, wherein the locker unit further comprises an ultraviolet sanitization system.

19. The system of claim 17, wherein the locker unit further comprises one or more of a heating unit and a cooling unit.

20. The system of claim 17, wherein the locker unit further comprises a camera configured to capture one or more of video data and image data of at least the storage compartment of the locker unit.

21. The system of claim 20, wherein the camera comprises a motion activated camera configured to begin capturing one or more of the video data and the image data upon detecting motion in or around the storage compartment.

22. The system of claim 20, wherein the camera is configured to capture one or more of the video data and the image data at a regular interval of time.

23. The system of claim 1, wherein the command comprises one of a lock command or an unlock command.

24. The system of claim 1, wherein the communication device and the locking mechanism are configured to communicate via an application programming interface.

25. The system of claim 1, wherein the expiring key comprises one or more of:
an expiring URL;
an alphanumeric code; and
a push notification to log into a user account on the mobile device.

26. The system of claim 1, wherein the communication unit is configured to communicate with the mobile device over a cellular or internet connection.

27. The system of claim 1, wherein the communication device comprises an external battery and an internal battery,
wherein the communication device communicates with the external battery,
wherein, when the communication device determines that a charge level of the internal battery reaches a threshold, the communication device is configured to instruct the external battery to charge the internal battery.

28. A communication device configured to:
receive an access request;
in response to receiving the access request, generate an expiring electronic key, wherein the expiring electronic key includes an expiration time;
send the expiring electronic key to a mobile device via a text messaging service;
receive an activation request for the expiring electronic key and a command for a locking mechanism from the mobile device;
perform a validation process on the mobile device; and
in response to validating the mobile device, send the command to the locking mechanism.

29. The communication device of claim 28, wherein the communication device comprises an external battery and an internal battery,
wherein the communication device communicates with the external battery,
wherein, when the communication device determines that a charge level of the internal battery reaches a threshold, the communication device is configured to instruct the external battery to charge the internal battery.

30. A method comprising:
receiving, by a communication device and from a mobile device, an access request;
in response to receiving the access request, generating, by the communication device, an expiring electronic key, wherein the expiring electronic key includes an expiration time;
sending, by the communication device and via a text message service, the expiring electronic key to the mobile device;
receiving, by the mobile device, the expiring electronic key from the communication device via the text message service;
activating, by the mobile device, the expiring electronic key; and
in response to activating the expiring electronic key, performing, by a locking mechanism, a command on the locking mechanism.
